(19) United States
(12) Patent Application Publication
(10) Pub. No.: US 2020/0375838 A1
(43) Pub. Date: Dec. 3, 2020

(54) SYSTEMS AND METHODS RELATED TO A MYOFASCIAL-RELEASING TREATMENT DEVICE

(71) Applicant: Myofascial Restoration and Integration, POMC, Walnut Creek, CA (US)

(72) Inventors: Edward Verceles, Walnut Creek, CA (US); Jason Michael Skipper, Concord, CA (US)

(73) Assignee: Myofascial Restoration and Integration, POMC, Walnut Creek, CA (US)

(21) Appl. No.: 16/888,880

(22) Filed: Jun. 1, 2020

Related U.S. Application Data
(60) Provisional application No. 62/854,992, filed on May 31, 2019.

(51) Int. Cl. A61H 7/00; A61H 23/00

(52) U.S. Cl. CPC A61H 7/003; A61H 23/004; A61H 7/005

(57) ABSTRACT

Myofascial-releasing devices and methods related thereto are described. The myofascial-releasing device includes: (i) a gripping portion designed for gripping by user, which includes: (a) a spine designed to receive hand and fingers in a gripping configuration; (b) a thumb stabilizing element protruding from the spine along a curved, protruding path that has defined therein a first web space of palm locking contour, which is designed to stabilize a user's first web space of palm and a surrounding region; and (c) finger stabilizing element protruding from the spine; and (ii) an extending portion that extends from a second end of the gripping portion and that terminates at an elongated end such that during use of the myofascial-releasing instrument, the elongated end is configured to be driven into muscle containing fascia, and the first end is opposite to the second end of the gripping portion.

### RELATED CASE

This application claims priority to U.S. provisional application No. 62/854,992, filed May 31, 2019, and is incorporated herein by reference for all purposes.

### FIELD

The present arrangements and teachings relate generally to systems and methods associated with a myofascial-releasing device, or a fascial-releasing device. More particularly, the present arrangements and teachings relate to systems and methods associated with a novel myofascial-releasing device that is used to release, or otherwise relieve tension in and/or disrupt, myofascial buildup in muscle and soft and/or connective tissue, which is associated with decreased mobility and range of motion, decreased sensation, pain, tension, inflammation, and other undesirable symptoms in patients.

### BACKGROUND

Myofascial release, or fascial release, is a safe and effective hands-on technique that involves applying pressure into myofascial tissue restrictions and/or build-up to eliminate pain, increase sensation, and/or restore motion of joints or other body components connected or coupled to fascia. Conventional fascial-release tools and techniques include using a body part (such as a thumb or other finger), or a forcefully gripped tool (such as a Graston tool) that is driven into fascia with sustained and/or alternating pressure until fascia release is achieved. Such fascia release may be thought of as “releasing” fascia restrictions that are causing pain, discomfort, loss of mobility, loss of sensation, or other such symptoms, due to fascia being scarred together, bound together, tangled, or otherwise misaligned. Thus, fascia release may be thought of as removing, unbinding, untangling, or realigning fascia to alleviate such symptoms.

Unfortunately, such conventional techniques and/or tools suffer from certain drawbacks. In particular, a user of such techniques and associated tools (e.g., a medical practitioner, massage therapist, chiropractor, etc.) applying sustained and/or alternating pressure to relieve fascia tension to relieve symptoms in a patent may suffer a great deal of fatigue, and ultimately, injury, when using such conventional techniques, particularly where the user is a medical practitioner, physical therapist, chiropractor, or the like, who repeatedly treats patients throughout a day, and who, over time, may develop repetitive stress problems from treating patients with applied force from the practitioner's hand on a regular basis. Further, conventional fascial-releasing tools and techniques, because they localize tension in a user's hand via forceful gripping, provide impaired tactile feedback and reduced “feel” to the user, compromising the user's ability to provide the most effective means of generating fascial release in a patient.

What is therefore needed are fascial-releasing devices and methods that are designed to be used or otherwise practiced without the necessity of a localized pressure and tension in the user's hand that fatigues and/or injures a user and that improves tactile feedback for the user to provide better patient treatment and care.

### SUMMARY OF THE INVENTION

To achieve the foregoing, in one aspect, the present arrangements disclose a myofascial-releasing instrument. The myofascial-releasing instrument includes: (i) a gripping portion designed for gripping by user, which includes: (a) a spine designed to receive hand and fingers in a gripping configuration and includes an extending body terminating, at a first end, at a thenar eminence stabilizing region for stabilizing thenar eminence; (b) a thumb stabilizing element protruding from the spine along a curved, protruding path that includes a first web space of palm locking contour, which is designed to stabilize a user's first web space of palm and a surrounding region; and (c) a finger stabilizing element protruding from the spine and that is designed to stabilize a middle finger, a ring finger, and at least portion of a pinkie finger; and (ii) an extending portion that extends from a second end of the gripping portion and that terminates at an elongated end such that during use of the myofascial-releasing instrument, the elongated end is configured to be driven into muscle containing fascia, and the first end is opposite to the second end of the gripping portion.

Preferably, the myofascial-releasing instrument includes: (i) a first multiple-finger stabilizing ridge protruding from the spine and defining a middle finger stabilizing contour on one side and defining at least a portion of a ring finger stabilizing contour on an opposite side, which is opposite to the one side, such that the middle finger stabilizing contour is designed to stabilize a middle finger and the ring finger stabilizing contour is designed to stabilize a ring finger; (ii) a second multiple-finger stabilizing ridge protruding from the spine and defining the ring finger stabilizing contour on the opposite side and a pinkie finger stabilizing contour on another side, which is opposite to the opposite side, such that the pinkie-finger stabilizing contour is designed to receive pinkie finger; (iii) a thenar eminence stabilizing region that represents a terminating extension of the spine and that is designed to stabilize a thenar eminence; (iv) a middle finger stabilizing region that is defined adjacent to the multiple-finger stabilizing ridge; and (v) a first web space of palm locking contour disposed on or adjacent to the spine, located proximate or adjacent to the middle finger stabilizing region, and designed to includes a thumb-stabilizing element disposed adjacent to the elongated end. Further, the myofascial-releasing instrument may also include an index finger stabilizing region disposed adjacent to the thumb-stabilizing region.

According to preferred embodiments of the present arrangements, the myofascial-releasing instrument also includes a tip engaged with the elongated end of the extending portion such that the tip is configured to be driven into muscle containing fascia. Preferably, the tip is detachable and may engage with the elongated end of the extending portion using a threaded engagement. The tip may be cylindrical, spherical, or pointed. In certain embodiments of the present arrangement, the tip is detachable. According to one embodiment of the present arrangements, the tip engages with the extending portion using a spring-loaded stem. The myofascial-releasing instrument may also include a cavity disposed inside the extending portion and that is configured to engage with tip. The tip may also supply vibrational energy to a patient's fascia, preferably by battery power.

According to preferred embodiments of the present arrangements, the extending portion of the myofascial-releasing instrument is configured not to cause a skin incision when in use.

In another aspect, the present teachings disclose a method of promoting myofascial release. The method includes: (i) obtaining a myofascial-releasing instrument that includes a gripping portion that has a spine, a thumb-stabilizing element, a finger-stabilizing element, and an extending portion, such that the spine includes an extending body terminating, at a first end, at a thenar eminence stabilizing region, with the thumb-stabilizing element protruding from the spine along a curved, protruding path that includes a first web space of palm locking contour, and a finger-stabilizing element protrudes from the spine, with an extending portion extending from a second end of the gripping portion and terminating at an elongated end, such that the first end is opposite to the second end of the gripping portion; (ii) gripping the gripping portion such that a user's hand and fingers wrap around the gripping portion in a gripping configuration, in which thenar eminence contacts and is stabilized against the thenar eminence stabilizing element, ring finger and at least portion of the little finger contact and are stabilized by the finger stabilizing element; and (iii) driving, holding the gripping configuration, the elongated end into muscle for effectively releasing fascia. Diving the elongated end into muscle may also include promoting myofascial release by driving, using the elongated end, into the muscle at a first vector for a first duration, and driving the elongated end into the muscle at a second vector for a second duration.

### BRIEF DESCRIPTION OF THE DRAWINGS

FIG. 1A is a view of a first side of a myofascial-releasing device, according to one embodiment of the present arrangements.

FIG. 1B is the side view of the myofascial-releasing device of FIG. 1A showing certain angular and linear dimensions associated with the device.

FIG. 1C is a side view of a user's hand gripping, according one embodiment of the present teachings, the myofascial-releasing device of FIG. 1A.

FIG. 2 is a top view of the myofascial-releasing device of FIG. 1, according to one embodiment of the present arrangements.

FIG. 3 is a bottom view of the myofascial-releasing device of FIG. 1, according to one embodiment of the present arrangements.

FIG. 4 is a view of a second side of the myofascial-releasing device of FIG. 1, according to one embodiment of the present arrangements.

FIG. 5A is a side view of an exemplar tip, according to one embodiment of the present arrangements, used with the myofascial-releasing devices of the present arrangements and having a spherical head.

FIG. 5B is a side view of an exemplar tip, according to another embodiment of the present arrangements, used with the myofascial-releasing devices of the present arrangements and having a cylindrical head.

FIG. 5C is a side view of an exemplar tip, according to another embodiment of the present arrangements, used with the myofascial-releasing devices of the present arrangements and having a relatively pointed head.

FIG. 6 is flowchart showing certain salient steps of a method of facilitating myofascial release, according to one embodiment of the present arrangements.

### DETAILED DESCRIPTION OF THE PREFERRED EMBODIMENTS

In the following description, numerous specific details are set forth in order to provide a thorough understanding of the present arrangements and teachings. It will be apparent, however, to one skilled in the art that the present teachings may be practiced without limitation to some or all of these specific details. In other instances, well-known process steps have not been described in detail in order to not unnecessarily obscure the present teachings.

The arrangements and teachings of the present inventions disclose myofascial-releasing devices and techniques that provide users of such devices and techniques the ability to practice myofascial release on patients without the fatigue, stress, and short- and long-term injuries associated with conventional myofascial-release techniques and devices. Further, as explained below, the contact point of the fascial-releasing devices of the present arrangements (i.e., the point that is driven into a patient's injured or otherwise restricted fascia to provide pain relief, improved range of motion, increased strength, increased sensation and relief from other undesirable symptoms) may be modified by the use of interchangeable tips that provide advantages to treatment of injured fascia issues in particular ways and/or in particular locations. In particular, a relatively larger tip (e.g., a spherical tip) may be used to distribute force over a relatively larger area, providing the advantage of less pain for the patient. Conversely, a relatively smaller tip (e.g., a cylindrical tip) may be used to focus force over a relatively smaller area, providing the advantage of treating fascia that is located beneath a relatively large amount of muscle or fat. Further, a relatively sharper shape (though not sharp enough to puncture skin when in use) may be used to achieve additional depth, allowing deeper fascia to be reached when the devices and methods of the present arrangements and teachings are used.

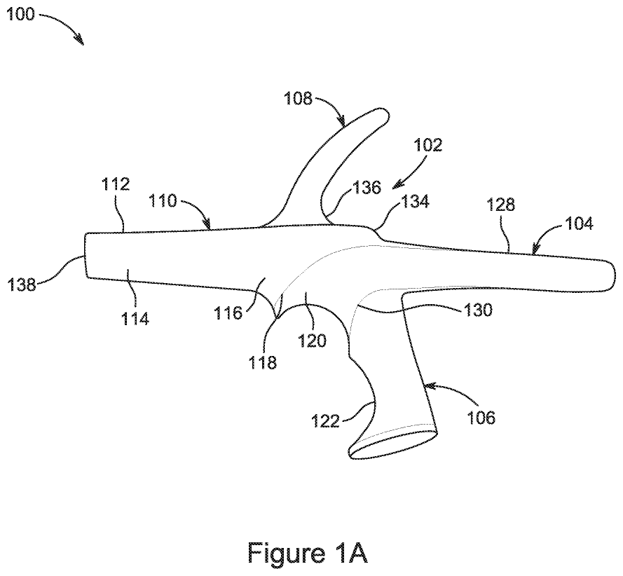

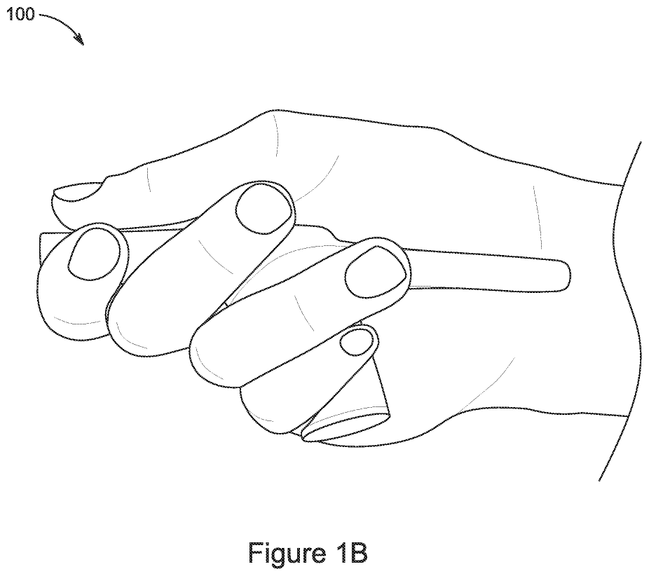

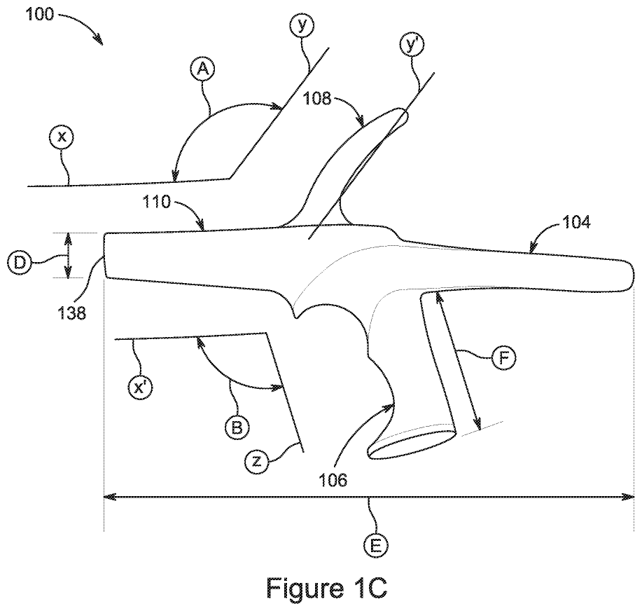

FIG. 1A is a side view of a myofascial-releasing device 100, according to preferred embodiments of the present arrangements. Myofascial-releasing device 100 include a gripping portion 102, a spine 104, a finger-stabilizing element 106, a thumb-stabilizing element 108, an extending portion 110, a thumb-stabilizing region 112, an index-finger stabilizing area 114, a middle-finger stabilizing contour 116, a first multiple-finger stabilizing ridge 118, a ring-finger stabilizing contour 120, a pinkie-finger stabilizing contour 122, a palm-stabilizing element 128, a second multiple-finger stabilizing ridge 130, a thenar eminence stabilizing region 134, a first web space of palm locking contour 136, and a tip-receiving end or portion 138. According to preferred embodiments of the present arrangements, each of these elements is configured to facilitate stabilizing the device in the user's hand without the need for a forceful grip. To this end, FIG. 1B shows a side view of a user's hand gripping device 100, according to one embodiment of the present arrangements. As shown in FIG. 1B, a user's index finger grips device 100 at an index-finger stabilizing area (e.g., index-finger stabilizing area 114 shown in FIG. 1A), a user's middle finger grips device 100 at a middle-finger stabilizing contour (e.g., middle-finger stabilizing contour 116 shown in FIG. 1A), a user's ring finger grips device 100 at or near a ring-finger stabilizing contour (e.g., ring-finger stabilizing contour 120 shown in FIG. 1A), a user's pinkie finger grips device 100 at or near a pinkie-finger stabilizing contour (e.g., pinkie-finger stabilizing contour 122 shown in FIG. 1A), a user's thumb is stabilized against a thumb-stabilizing region (e.g., thumb-stabilizing region 112 shown in FIG. 1A), a user's first web space of palm is pressed against a first web space of palm locking contour (e.g., first web space of palm locking contour 136 shown in FIG. 1A), a user's palm is stabilized against a palm-stabilizing element (e.g., palm-stabilizing element 128 shown in FIG. 1A), and a user's thenar eminence is stabilized against a thenar eminence stabilizing region (e.g., thenar eminence stabilizing region 134 shown in FIG. 1A). The present teachings recognize, however, that devices of the present arrangements may be gripped in other ways that account for factors such was a user's hand size and/or shape. By way of example, a user's fingers may be shifted along the a device such that a user's index finger grips device 100 at or near a middle finger stabilizing contour, a user's middle finger grips device 100 at or near a ring-finger stabilizing contour, a user's ring finger grips device 100 at or near a pinkie-finger stabilizing contour, and a user's pinkie grips device 100 near a bottom end or edge of a finger-stabilizing element (e.g., finger-stabilizing element 106 as shown in FIG. 1A) or is not used to grip device 100 when in use.

In certain embodiments of the present arrangements, one or more of the features listed above may be absent while maintaining the ability of the device to be stabilized in the user's hand without the need for a forceful grip. By way of example, one or both of ridges 118 and 130 may not be defined on device 100 while nevertheless maintaining placement of a user's hand on the same locations and/or contours of the device.

The present teachings recognize, further, that the configuration shown in FIG. 1A presents multiple primary contact points with the user's anatomy when the present device is gripped by a user. These contact points provide the advantage of stabilization of the device, by the user, without the use of a forceful grip. Preferably, the contact points include thumb-stabilizing region 112, index-finger stabilizing area 114, middle-finger stabilizing contour 116, ring-finger stabilizing contour 120, pinky-finger stabilizing contour 122, thenar eminence stabilizing region 134, and first web space of palm locking contour 136. The present teachings also recognize that one or more adjoining regions or areas may be considered a single contact point.

In particular, the use of multiple points distributes force, when the present device is in use, proximally into a user's bicep, shoulder, and/or torso, which are relatively larger muscles that are thus amenable to continued application of force by the user. In other words, by engaging these larger muscles, forces associated with applying myofascial-release techniques are diverted away from a user's hand and/or arm to these muscles. Thus, the user may avoid such complications as pain and fatigue with other conventional methods and devices when using the present device for multiple hours in a day and/or on a day-to-day basis. The present teachings contemplate any number of multiple contact points to facilitate distribution of such forces to a user's various upper-body muscle groups.

Gripping portion 102 may be thought of as the region on device 100 where the user focuses his or her grip on devices of the present arrangements at or near multiple contact points disposed on devices of the present arrangements. In other words, gripping portion 102 is where a user engages his or her palm and adjoining areas on devices of the present arrangements and is from where his or her fingers wrap around the device to facilitate gripping.

Spine 104 is a region extending away from gripping portion 102 towards a user's body when device 100 is in use. In preferred embodiments of the present arrangements, a user's palm area engages with a top surface of spine 104 (i.e., at palm-stabilizing region 128) to stabilize the device when in use.

Finger-stabilizing element 106 is a region where at least one member chosen from a group comprising a user's little finger (i.e., pinkie finger), ring finger (i.e., lazy finger), and middle finger, is stabilized on device 100. In certain embodiments of the present arrangements, a user's index finger is stabilized on finger-stabilizing element 106.

Thumb-stabilizing element 108 is the region extending curvilinearly away from device 100 that provides a region, at or near its attachment point to device 100, where the bottom end of a user's thumb at or near a user's web space of palm (i.e., at first web space of palm locking contour 136), as well as surrounding regions on the user's hand, are stabilized when device 100 is in use and gripped by a user.

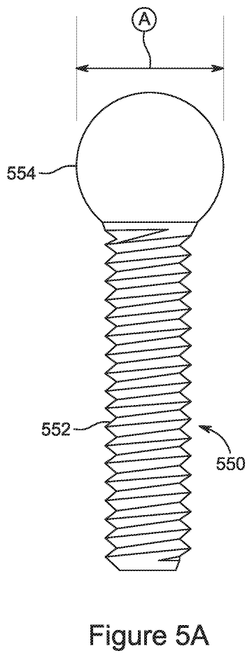

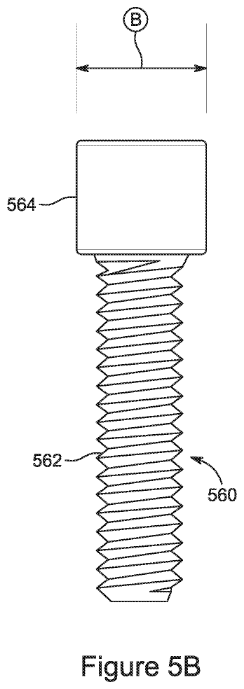

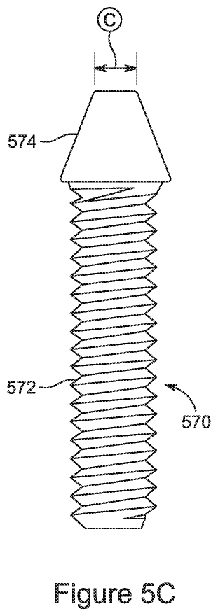

Extending portion 110 is the portion of device 100 that extends towards, onto, and/or into the surface of a patient when device 100 is in use. An elongated end of extending portion may be considered the region where a tip may be engaged with device 100 (i.e., at or near tip-receiving portion 138) (described below). It is important to note, however, that extending portion 110, while appearing relatively sharp in FIG. 1, is configured not to be a sharp edge. In other words, the present teachings recognize that extending portion 110 is configured such that it will not cause an incision on a patient's skin when devices of the present arrangements forcefully contact a patient's skin when in use. Extending portion 110 may be thought of as the area of device 100 that is either used to press into fascia to promote fascial release, or is coupled to a tip (e.g., as described below with reference to FIGS. 5A-5C) that presses into fascia to promote fascial release.

Thumb-stabilizing region 112 is a region on a top surface of extending portion 110 that stabilizes a user's thumb (i.e., at or near a user's thumbprint region) when device 100 is in use. In other words, according certain embodiments of the present arrangements, a user presses his or her thumb against thumb-stabilizing region 112 when device 100 is in use.

Index-finger stabilizing region or area 114 is a region at or near a bottom area and/or a side area of extending portion 110 where a user's index finger (i.e., at or near a fingerprint region) presses against and grips device 100.

Middle-finger stabilizing contour 116 is a region that receives a user's middle finger. In other words, according to certain embodiments of the present arrangements, a user gripes his or her middle finger at or near contour 116 when device 100 is in use.

First multiple-finger stabilizing ridge 118 is a raised portion on device 100 that helps create and divide middle-finger stabilizing contour 116 and ring-finger stabilizing contour 120. In other words, when device 100 is in use, a user's middle finger and ring finger are separated by, or distributed along, first multiple-finger stabilizing ridge 118. To this end, ring-finger stabilizing contour 120 is a region where a user's ring finger engages and grips device 100 when it is in use.

Pinky-finger contour 122 is a region on device 100 where a user's pinkie finger engages and grips device 100 when it is in use.

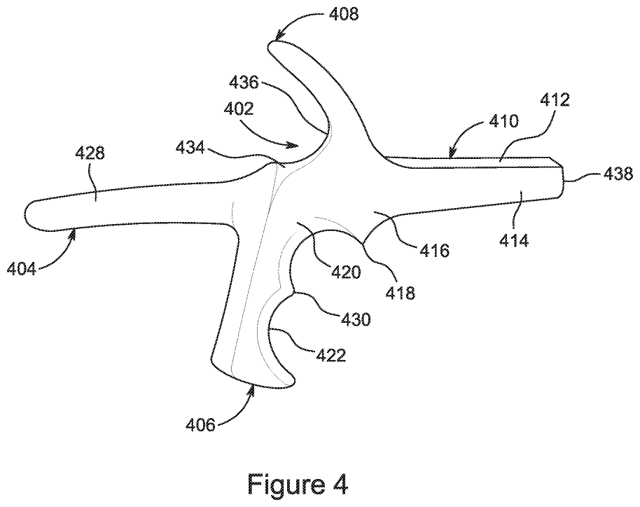

Palm-stabilizing element 128, or palm-stabilizing region 128, is a region on a side surface of spine 104 where a user's palm presses against and/or engages to stabilize device 100 when it is in use. According to preferred embodiments of the present arrangements, element 128 is located on the side opposite to what is depicted in FIG. 1A (e.g., as shown with respect to palm stabilizing element 428 in FIG. 4).

Second multiple-finger stabilizing ridge 130 is a raised portion on device 100 that helps create and divide ring-finger stabilizing contour 120 and pinkie-finger stabilizing contour 122. In other words, when device 100 is in use, a user's ring finger and pinky finger are separated by, or distributed along, second multiple-finger stabilizing ridge 130. In certain embodiments of the present arrangements, however, ridge 130 is not implemented.

Thenar eminence stabilizing region 134 is a region where a user's thenar eminence engages with device 100 when in use. In certain embodiments of the present arrangements, a user's thenar eminence simultaneously engages at or near palm-stabilizing element 128. Preferably, a thenar eminence stabilizing region is predominantly disposed on an opposite side of device 100 (e.g., as shown with respect to thenar eminence stabilizing region 434 in FIG. 4).

First web space of palm locking contour 136 is a region on device 100 where a base of a user's thumb and a user's first web space of palm region (i.e., the area surrounding the base of a user's thumb) engages with device 100 when device 100 is in use.

Though certain embodiments of the present arrangements use multiple ridges and contours to define specific spaces where the user's fingers engage with device 100, other embodiments of the present arrangements do not require specifically defined ridges and/or contours to provide multiple contact points where a user's hand engages with the fascial-releasing devices of the present arrangements.

Tip-receiving portion 138 is a region on extending portion 110 of device 100 that engages with a tip (i.e., a component coupled to device 100 that contacts a patient when device 100 is in use, as described in further detail below with respect to FIGS. 5A-5C). Though use of a tip at portion 138 represents preferred embodiments of the present arrangements, in alternate embodiments of the present arrangements, portion 138 is itself configured to engage with a patient when device 100 is in use, and in such manner, may also be thought of as a tip. In other embodiments of the present arrangements, however, a tip is attached to tip-receiving portion 138. Such tips may be detachable and/or interchangeable with one or more other tips.

Attachment of a tip to tip-receiving portion 138 may be carried out by any mechanism well-known to those of skill in the art. As one example, tip-receiving portion 138 may be configured with a cavity (i.e., a “female connector”) that receives one end of a tip (i.e., a “male connector) and stabilizes the tip in place when device 100 is in use. In certain embodiments of the present arrangements, tip-receiving portion 138 and a tip may be configured to snugly fit together to promote stabilization of a tip with the device. In another embodiment of the present arrangements, to facilitate such attachment, one end of a tip is configured as a screw (i.e., as shown in FIGS. 5A, 5B, and 5C) having a scored portion that engages with threaded grooves that are defined within tip-receiving portion 138. In another embodiment of the present arrangements, a scored portion is disposed around tip-receiving portion 138, and a connecting end of a tip is configured as a cavity with threaded grooves disposed therein that engage with the scored portion to connect a tip to tip-receiving portion 138. According to another embodiment of the present arrangements, a tip is configured with a stem that is spring-loaded on or in tip-receiving portion 138. Other attachment mechanisms well known to those of skill in the art are contemplated.

FIG. 1C depicts certain linear and angular dimensions associated with certain embodiments of device 100 of FIG. 1A. To this end, spine 104, finger-stabilizing element 106, thumb-stabilizing element 108, extending portion 110, and tip-receiving portion 138 are substantially similar to their counterparts in FIG. 1A. While certain exemplar values are discussed below, the present teachings recognize that devices of the present arrangements may be configured with dimensions that are adapted to use by varying hand sizes and shapes of a user.

As shown in FIG. 1C, element “A” depicts an angular distance between thumb-stabilizing element 108 and extending portion 110. Angular distance A in FIG. 1B may be thought of as an angular distance created by intersection of lines x and y, where line x is substantially parallel to a top end of extending portion 110, and line y is substantially parallel to a line y′, which is a line that intersects a centerpoint of a bottom of thumb-stabilizing element 108 and a centerpoint of a top end of thumb-stabilizing element 108. Preferably, angular distance A is value that is between about 90° and about 135°, more preferably between about 100° and about 120°, and more preferably about 115°.

Element “B” depicts an angular distance between finger-stabilizing element 106 and extending portion 110. Angular distance B in FIG. 1B may be thought of as an angular distance created by intersection of lines x′ and z, where line x′ is substantially parallel to line x, and line z is substantially parallel to a back end (i.e., the end further away from tip-receiving portion 138) of finger-stabilizing element 106. Preferably, angular distance B is value that is between about 90° and about 150°, and more preferably between about 100° and about 130°.

Element “D” shows a width of tip-receiving portion 138. Preferably, width D is a value that is between about 0.5 cm and about 2.0 cm, more preferably between about 1.0 cm and about 1.5 cm, and more preferably about 1.15 cm.

Element “E” shows a linear distance between a first, attaching end of finger-stabilizing element 106, and a second, opposite end of finger-stabilizing element 106. Preferably, linear distance E is a value that is between about 5 cm and about 25 cm, more preferably between about 10 cm and about 20 cm, and more preferably about 15 cm.

Element “F” shows a linear distance of a back end of finger-stabilizing element 106. Preferably, linear distance F is a value that is between about 3 cm and about 6 cm, more preferably between about 4 cm and about 5 cm, and more preferably, about 4.5 cm.

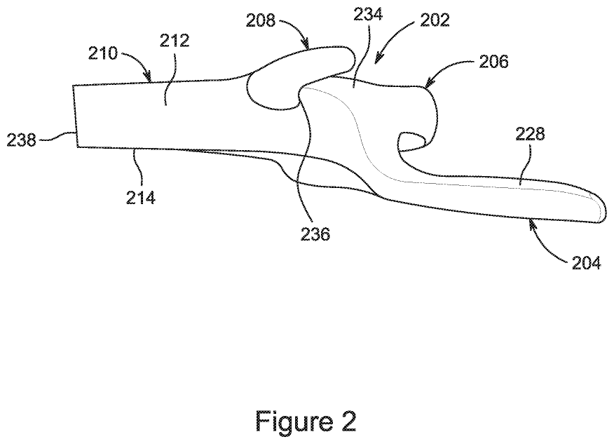

FIG. 2 is a top view of fascial-releasing device 100, according to one embodiment of the present arrangements. A gripping portion 202, a spine 204, a finger-stabilizing element 206, a thumb-stabilizing element 208, an extending portion 210, a thumb-stabilizing region 212, an index-finger stabilizing area 214, a palm-stabilizing element 228, a thenar eminence stabilizing region 234, a first web space of palm locking contour 236, and a tip-receiving portion 238, are substantially similar to their counterparts in FIG. 1, i.e., gripping portion 102, spine 104, finger stabilizing element 106, thumb-stabilizing element 108, extending portion 110, thumb-stabilizing region 112, index-finger stabilizing area 114, palm-stabilizing element 128, thenar eminence stabilizing region 134, first web space of palm locking contour 136, and tip-receiving portion 138.

Though FIG. 2 shows thumb-stabilizing region 212 as relatively flat, the present teachings recognize that thumb-stabilizing region 212 may have a relatively curved, cupped, and/or spherical configuration. As shown in FIG. 2, the surface of thumb-stabilizing region 212 is where a user's thumb engages with devices of the present arrangements.

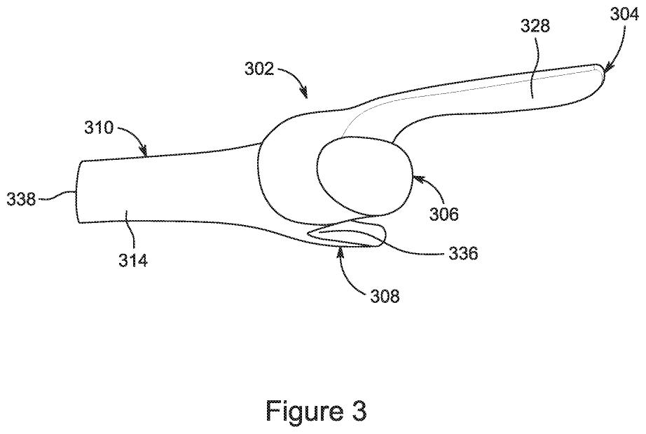

FIG. 3 is a bottom view of fascial-releasing device 100, according to one embodiment of the present arrangements. A gripping portion 302, a spine 304, a finger stabilizing element 306, a thumb-stabilizing element 308, an extending portion 310, an index finger stabilizing area 314, a palm-stabilizing element 328, a first web space of palm locking contour 336, and a tip-receiving portion 338, are substantially similar to their counterparts in FIG. 1, i.e., gripping portion 102, spine 104, finger stabilizing element 106, thumb-stabilizing element 108, extending portion 110, index finger stabilizing area 114, palm stabilizing element 128, first web space of palm-locking contour 136, and tip-receiving portion 138.

FIG. 4 is a side view (i.e., the opposite side to the view shown in FIG. 1A) of the fascial-releasing device 100 of FIG. 1, according to one embodiment of the present arrangements. FIG. 4 shows a gripping portion 402, a spine 404, a finger stabilizing element 406, a thumb-stabilizing element 408, an extending portion 410, a thumb-stabilizing region 412, an index-finger stabilizing area 414, a middle-finger stabilizing contour 416, a first multiple-finger stabilizing ridge 418, a ring-finger stabilizing contour 420, a pinkie-finger stabilizing contour 422, a palm-stabilizing element 428, a second multiple-finger stabilizing ridge 430, a thenar eminence stabilizing region 434, a first web space of palm locking contour 436, and a tip-receiving portion 438, which are substantially similar to their counterparts in FIG. 1, i.e., gripping portion 102, spine 104, finger-stabilizing element 106, thumb-stabilizing element 108, extending portion 110, thumb-stabilizing region 112, index-finger stabilizing area 114, middle-finger stabilizing contour 116, first multiple-finger stabilizing ridge 118, ring-finger stabilizing contour 120, pinkie-finger stabilizing contour 122, palm-stabilizing element 128, second multiple-finger stabilizing ridge 130, thenar eminence stabilizing region 134, first web space of palm locking contour 136, and tip-receiving portion 138.

Device 100 may be comprised of any material with solidity sufficient to withstand use in the manner described herein. By way of example, device 100 may be comprised of any metal, such an aluminum, stainless steel, copper, and the like, or any combination thereof. Alternatively, device 100 may be comprised of plastic or plastic composites. Plastic or plastic composites provides certain advantages insofar as these are relatively less expensive materials and are also more easily modified to account for varying designs. Conversely, devices comprised of metals are relatively more durable. Further, use of a relatively stiffer, or more rigid, material such as metal provides certain other advantages to the user. For example, a stiffer or more rigid material such as metal is more suitable for transmitting vibrational forces and thus provides more tactile feedback to the user, allowing a user to more easily detect injured fascia and/or to detect fascial release.

FIG. 5A is a side view of a tip 550, according to one embodiment of the present arrangements. Tip 550 includes a scored engaging portion 552 connected at one end to a spherical head 554. As shown in FIG. 5A, engaging portion 552 is configured as a screw that is capable of engaging within a tip-receiving portion with corresponding threaded grooves in myofascial-releasing devices of the present arrangements (e.g., tip-receiving portion 138 of device 100 as depicted in FIG. 1). In such manner, tip 550 may be thought of as detachable. Spherical head 554 may be thought of as the portion of tip 550 that is forcefully pressed, by a user, to contact a patient to facilitate myofascial release in the patient.

Element “A” in FIG. 5A depicts a diameter of spherical head 554. Preferably, diameter A of spherical head 554 has a value that is between about 10 mm and about 30 mm, more preferably between about 15 mm and about 25 mm, and more preferably, about 20 mm. Engaging portion 552 preferably has a length value that is between about 1 cm and about 4 cm.

According to the embodiment of FIG. 5A, a tip-receiving portion (e.g., tip-receiving portion 138 of FIG. 1) is configured with a cavity disposed therein having dimensions sufficient to receive, engage, and/or stabilize engaging portion 552.

The spherical configuration of head 554 provides certain advantages. For example, spherical head 554 is more appropriate for treating relatively superficial fascia or areas of increased sensitively (e.g., a hand), as a spherical head provides the advantage of a relatively larger surface area that contacts and is driven into a patient's fascia. This, in turn, distributes applied force over a larger treatment area of a patient, rendering treatment of fascia and fascial release more tolerable and less painful to the patient. Further, the present teachings recognize that a spherical tip with a broader surface provides more contact to areas where fascia is relatively thin (e.g., hand or forearm), The present teachings recognize, however, that any tip that provides a relatively larger surface area may be used to the same or similar effects.

FIG. 5B is a side view of a tip 560, according to one embodiment of the present arrangements. Tip 560 includes a scored engaging portion 562 connected at one end to a cylindrical head 564. Engaging portion 562 is substantially similar to its counterpart in FIG. 5A (i.e., engaging portion 552) and provides similar advantages of detachability, as well as stability when the devices of the present arrangements are in us. As with spherical head 554 of tip 550, cylindrical head 564 may be thought of as the portion of tip 560 that is forcefully pressed, by a user, to contact a patient to facilitate myofascial release in the patient.

The cylindrical configuration of head 564 provides certain advantage over alternate configurations. For example, the relatively smaller surface area of cylindrical head (e.g., relative to a spherical head, such as spherical head 554 of tip 550), allows a user to achieve increased depth of fascial pressure when devices of the present arrangements are in use. In such manner, use of a cylindrical tip (or, alternately, any shaped tip having a relatively smaller surface area) is more appropriate for treating areas of the body that have relatively higher amounts of muscle or fat (e.g., a back or a thigh), as the smaller tip surface area facilitates a user's ability to drive a tip deeper into a patient. Further, a smaller surface area of a cylindrical head (e.g., as compared to a tip with a spherical head) allows for more precise contact of fascia by a user.

Element “B” in FIG. 5B depicts a diameter of a top end of cylindrical head 564. Preferably, diameter B of cylindrical head 564 has a value that is between about 10 mm and about 30 mm, more preferably between about 15 mm and about 25 mm, and more preferably, about 20 mm. Engaging portion 562 preferably has a length value that is between about 1 cm and about 4 cm.

FIG. 5C is a side view of a tip 570, according to one embodiment of the present arrangements. Tip 570 includes a scored engaging portion 572 connected at one end to a cylindrical head 574. Engaging portion 562 is substantially similar to its counterpart in FIGS. 5A and 5B (i.e., engaging portion 552 and engaging portion 562, respectively) and provides similar advantages of detachability, as well as stability when the devices of the present arrangements are in us. As with spherical head 554 of tip 550 and cylindrical head 564 of tip 560, pointed head 574 of tip 570 may be thought of as the portion of tip 570 that is forcefully pressed, by a user, to contact a patient to facilitate myofascial release in the patient. The relatively pointed configuration of tip 570 provides certain advantages when in use, as its pointed configuration allows a user to drive a tip relatively further into a patient, reaching problematic fascia disposed relatively deeply within a patient. While FIG. 5C shows pointed head 574 as relatively pointed, the present teachings recognize that pointed head 574 is nevertheless configured to be sufficiently blunt such that it does not puncture skin when devices of the present arrangements are in use.

Element “C” in FIG. 5C depicts a diameter of a top end of pointed head 564. Preferably, diameter C of pointed head 574 has a value that is between about 5 mm and about 15 mm, more preferably between about 7 mm and about 13 mm, and more preferably, about 10 mm. Engaging portion 572 preferably has a length value that is between about 1 cm and about 4 cm.

The present teachings recognize that a tip's length, surface area, and/or shape are variables that may be adjusted to suit the particular fascia being treated, the location of the fascia on the body, and the needs and sensitivities of the patient being treated. The present teachings, however, contemplate use of tips of varying lengths, surface area, and/or shape, to facilitate effective fascial-release.

The present teachings contemplate use of tips of varying shapes or dimensions so long as they promote fascial-release in a patient when devices of the present arrangements are in use. For example, a tip may be configured to mimic the shape of a thumb or finger. Further, a tip may be configured at varying lengths to facilitate reaching deeper fascia for treatment, which is useful when treating fascia disposed deeper in a user, such as within the backside or thighs.

A tip that is attached to or otherwise disposed on devices of the present arrangements may be comprised of any material with solidity sufficient to withstand use in the manner described herein. In preferred embodiments of the present arrangements, however, a tip is comprised of metal. Use of a metal tip provides the advantage of increased stiffness that is more amenable to transmitting the “feel” of the fascia (i.e., through detection of vibrational changes that are delivered via the metal tip when in use) to the user. In such manner, a metal tip provides the same advantages associated with a user applying his or her thumb or finger to treat fascia (which are used by the user to detect vibrational changes associated with fascia treatment), without the fatigue associated with treatment carried out using a thumb or finger. Particular metals or other materials may also be used in a tip connected to device 100 to account for a patient's allergies to one or more other specific metal types.

Tips that incorporate additional useful features are also contemplated. As one example, a tip capable of providing vibrations (e.g., via battery power) may be useful in promoting myofascial-release and treatment. For example, a user may apply vibrations to a patient's damaged or inflamed fascia to further facilitate fascial release. As another example, vibrations provided by a tip may be used to identify fascia requiring treatment. The present teachings recognize that vibrations provided to fascia will advance along a “fascial line” to another part of the user's body. By supplying vibrations to such fascia, a user may detect vibrations at another part of the user's body connected to the fascial line. To the extent such vibrations are not detected, then the user has identified fascia potentially requiring treatment.

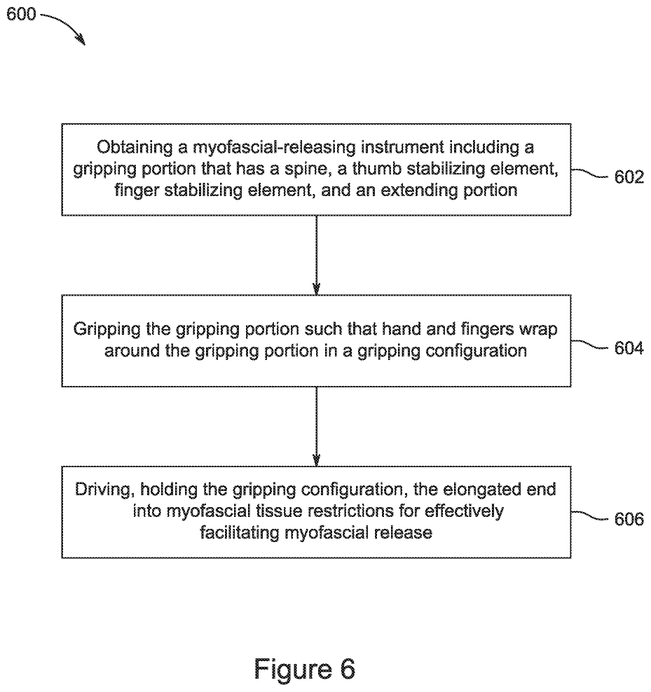

Treatment of a patient to promote fascial release using the fascial-releasing devices of the present teachings may be carried out by any number of techniques. To this end, FIG. 6 shows a flowchart of certain salient steps of a process 600, according to one preferred embodiment of the present arrangements, for promoting fascial release in a patient. Process 600 begins with a step 602, which includes obtaining a myofascial-releasing instrument (e.g., device 100 of FIG. 1A) that includes a gripping portion (e.g., gripping portion 102 of FIG. 1A) that has a spine (e.g., spine 104 of FIG. 1A), a thumb-stabilizing element (e.g., thumb-stabilizing element 108 of FIG. 1A), a finger-stabilizing element (e.g., finger-stabilizing element 106 of FIG. 1A), and an extending portion (e.g., extending portion 110 of FIG. 1A). Preferably, the spine includes an extending body (e.g., an extending body that terminates at a first end, at a thenar eminence stabilizing region such that the thumb-stabilizing element protrudes from the spine along a curved, protruding path that has defined therein a first web space of palm locking contour (e.g., first web space of palm locking contour 136 of FIG. 1A), and the finger-stabilizing element protrudes from the spine.

Next, a step 604 includes a user gripping the device at the gripping portion such that the user's hand and fingers wrap around the gripping portion in a gripping configuration such that the user's first web space of palm contacts and is stabilized against the first web space of palm stabilizing contour, the muscle of thenar eminence contacts and is stabilized against the thenar eminence stabilizing region, and the middle finger and at least portion of the pinkie finger contact and are stabilized by the finger stabilizing element. In preferred embodiments of the present arrangements, a tip (e.g., tips 550, 560, or 570 of FIGS. 5A, 5B, and 5C, respectively) is attached to a tip-receiving portion (e.g., tip-receiving portion 138 of FIG. 1A).

Next, a step 606 includes driving, while holding the device in a gripping configuration, the elongated end (e.g., at or near a tip-receiving portion) into myofascial tissue restrictions for effectively facilitating myofascial release in a patient. Driving in step 606 preferably includes driving a tip that is coupled to a tip-receiving portion into a patient's fascia to promote myofascial release.

During driving in step 606, a user contacts or engages, preferably using a device's tip, a location on a patient that is associated with fascial tension (e.g., an area where a patient suffers pain, inflammation, restricted mobility, loss of sensation, and other undesirable symptoms associated with fascial restriction or injury) and applies pressure on that point until the user detect the fascial tension. The user then may maintain pressure, increase pressure, and/or alter the vector of pressure application in order to release that tension. The processes disclosed herein may be carried out at different locations on a patient, multiple times and/or for prolonged periods of time, at different angles and vectors, at varying depths, at varying pressures, and these factors may be adjusted to accommodate a patient's responses and/or pain tolerance.

Efficacy of the treatment may be determined in various ways. As one example, a user (e.g., doctor, medical practitioner, a physical therapist, a chiropractor, a lay person, and/or a self-treating patient) may detect fascial release simply from the release of tension detected through vibrations produced during treatment. As another example, a patient may detect a reduction in pain after effective treatment is performed (though in some cases pain reduction may not be detected until hours or days after treatment). As yet another example, a patient may have increased mobility after successful treatment is performed. Such increased mobility may be measured, for example, by determining range of motion (e.g., of a knee) prior to and after treatment, where effective treatment will show increased range of motion thereafter.

The devices of the present teachings and arrangements provide certain advantages over conventional devices or techniques. In particular, the use of a relatively smaller contact area with the patient provides greater precision in treating fascia. This in turn provides the advantage, to the patient, of reducing side effect associated with conventional devices and treatments, such as pain, skin irritation (e.g., abrasions, welting, erythema), and bruising.

The present teachings further recognize that increased precision associated with the fascial-releasing devices disclosed herein produce superior and sustained improvement to a patient relative to use of conventional devices (including a thumb or finger). The present teachings recognize that fascia may be rich in nerve endings that sense pressure and tension, so the structure of fascia may be manipulated by a user without direct contact. Accordingly, increased precision associated with the devices of the present teachings facilitates altering the structure of defective fascia (i.e., the fascia being treated) while minimizing or eliminating disturbance to the adjacent “healthy” fascia that does not need to be treated. In other words, the increased precision associated with the fascial-releasing devices of the present arrangements focuses treatment only on defective fascia.

Further, use of the fascial-releasing devices of the present teachings and arrangements provides certain advantages to the user (e.g., physician, health care practitioner, self-use, etc.) over conventional devices and techniques, which requires the use of stronger and tighter grips that can produce fatigue and repetitive stress issues in the user (which is also the case for users that treat fascia issues with a thumb or finger). In particular, the fascial-releasing devices of the present teachings, when in use, provide multiple contact and stabilizing points that allow the user to avoid use of a forceful grip. In such manner, forces associated with using the fascial-releasing devices of the present teachings and arrangements are distributed to the relatively larger and stronger muscles of the upper arm and torso, which are better suited to absorb repetitive stress and strain without imparting deleterious consequences to the user. Conversely, use of a device that requires a stronger grip, or use of a thumb or finger, localizes forces to the relatively smaller and weaker muscles of the thumb, hand and forearm, which are less suited to tolerating repetitive, forceful strain. In particular, conventional devices tend to use fewer contact points than the fascial-releasing devices of the present teachings, which thus requires the user to use a more forceful grip.

Not only do the fascial-releasing devices of the present teaching provide advantages to the user in terms of avoiding injury and stress, from a treatment standpoint, avoiding use of increased tension in the hands associated with conventional treatment devices provides a more effective means of treating patients with using fascial-releasing techniques. In particular, a less forceful grip improves tactile feedback and improved feel for the user, which facilitates more effective treatment.

The fascial-releasing devices of the present teachings and arrangements may also be used to facilitate various treatment techniques for promoting fascial release. For example, they may be used to apply constant pressure at a constant vector, they may be used in conjunction with patient movement, they may be used to help a patient focus on activating a specific muscle (e.g., by providing a physical point on which a patient may focus while a user applies a fascial-releasing device upon that point) to facilitate rehabilitation of musculature.

Although illustrative embodiments of the present arrangements and teachings have been shown and described, other modifications, changes, and substitutions are intended. Accordingly, it is appropriate that the appended claims be construed broadly and in a manner consistent with the scope of the disclosure, as set forth in the following claims.

What is claimed is:

1. A myofascial-releasing instrument comprising:
a gripping portion designed for gripping by user, said gripping portion comprising:
a spine designed to receive hand and fingers in a gripping configuration and includes an extending body terminating, at a first end, at a thenar eminence stabilizing region for stabilizing thenar eminence;
a thumb stabilizing element protruding from said spine along a curved, protruding path that has defined therein a first web space of palm locking contour, which is designed to stabilize first web space of palm and surrounding region; and
a finger stabilizing element protruding from said spine and designed to stabilize middle finger, ring finger and at least portion of pinkie finger; and
an extending portion that extends from a second end of said gripping portion and that terminates at an elongated end such that during use of said fascia releasing instrument, said elongated end is configured to be driven into muscle containing fascia, wherein said first end is opposite to said second end of said gripping portion.

2. The myofascial-releasing instrument of claim 1, further comprising:
a first multiple-finger stabilizing ridge protruding from said spine and defining a middle finger stabilizing contour on one side and defining at least a portion of a ring finger stabilizing contour on an opposite side, which is opposite to said one side, wherein said middle finger stabilizing contour being designed to stabilize a middle finger and wherein said ring finger stabilizing contour being designed to stabilize a ring finger;
a second multiple-finger stabilizing ridge protruding from said spine and defining said ring finger stabilizing contour on said opposite side and a pinkie finger stabilizing contour on another side, which is opposite to said opposite side, wherein said pinkie-finger stabilizing contour is designed to receive pinkie finger; and
a thenar eminence stabilizing region that represents a terminating extension of said spine and is designed to stabilize a thenar eminence;
a middle finger stabilizing region that is defined adjacent to said multiple-fingers stabilizing ridge; and
a first web space of palm locking contour disposed on or adjacent to said spine, located proximate or adjacent to said middle finger stabilizing region, and designed to stabilize a first web space of palm.

3. The myofascial-releasing instrument of claim 2, further comprising a thumb-stabilizing element disposed adjacent to said elongated end.

4. The myofascial-releasing instrument of claim 3, further comprising and index finger stabilizing region disposed adjacent to said thumb-stabilizing region.

5. The myofascial-releasing instrument of claim 4, further comprising a tip engaged with said elongated end of said extending portion such that said tip is configured to be driven into muscle containing fascia.

6. The myofascial-releasing instrument of claim 5, wherein said tip engages with said elongated end of said extending portion using a threaded engagement.

7. The myofascial-releasing instrument of claim 5, wherein said tip is cylindrical, spherical, or pointed.

8. The myofascial-releasing instrument of claim 5, wherein said tip is detachable.

9. The myofascial-releasing instrument of claim 5, wherein said tip engages with said extending portion using a spring-loaded stem.

10. The myofascial-releasing instrument of claim 9, wherein said extending portion includes a cavity that is configured to engage with said tip.

11. The myofascial-releasing instrument of claim 6, wherein said tip includes a scored engaging portion configured to engage with threaded grooves within said cavity.

12. The myofascial-releasing instrument of claim 6, wherein said extending portion includes threaded grooves disposed around an outer surface of said extending portion and said tip is configured to engage with said threaded grooves to stabilize said tip.

13. The myofascial-releasing instrument of claim 1, wherein said extending portion is configured not to cause a skin incision when in use.

14. The myofascial-releasing instrument claim 5, wherein said tip is configured to supply vibrational energy.

15. The myofascial-releasing instrument of claim 14, wherein said vibrational energy is supplied by a battery.

16. A method of promoting fascial release, said method comprising:
obtaining a fascial-releasing instrument including a gripping portion that has a spine, a thumb stabilizing element, a finger stabilizing element and an extending portion, wherein said spine includes an extending body terminating, at a first end, at a thenar eminence stabilizing region, wherein said thumb stabilizing element protrudes from said spine along a curved, protruding path that has defined therein a first web space of palm locking contour, wherein said finger stabilizing element protrudes from said spine, wherein said an extending portion that extends from a second end of said gripping portion and that terminates at an elongated end, and wherein said first end is opposite to said second end of said gripping portion; and
gripping said gripping portion such that hand and fingers wrap around said gripping portion in a gripping configuration, in which (i) thenar eminence contacts and is stabilized against said thenar eminence stabilizing element; (ii) ring finger and at least portion of said little finger contact and are stabilized by said finger stabilizing element; and
driving, holding said gripping configuration, said elongated end into muscle for effectively releasing fascia.

17. The method of promoting fascial release of claim 16, wherein said driving includes driving said elongated end into said muscle at a first vector for a first duration and driving said elongated end into said muscle at a second vector for a second duration.
